(19) United States
(12) Patent Application Publication
(10) Pub. No.: US 2016/0028284 A1
(43) Pub. Date: Jan. 28, 2016

(54) ELECTRIC MACHINE

(71) Applicant: FEAAM GmbH, Neubiberg (DE)

(72) Inventor: Gurakuq DAJAKU, Neubiberg (DE)

(21) Appl. No.: 14/805,401

(22) Filed: Jul. 21, 2015

(30) Foreign Application Priority Data
Jul. 22, 2014 (DE) 102014110299.1

(51) Int. Cl. H02K 3/28; H02K 3/12; H02K 3/22

(52) U.S. Cl. CPC H02K 3/28; H02K 3/22; H02K 3/12

(57) ABSTRACT

The invention proposes an electric machine with a stator and a rotor that is movably supported relative thereto. The stator features a plurality of slots for accommodating a stator winding. The stator winding comprises several conductor sections that are respectively placed into each slot of the stator. On one side of the stator, the conductor sections are electrically short-circuited with one another in a short-circuit means. The short-circuit means comprises a cooling device.

The present invention pertains to an electric machine with a stator and a rotor that is movably supported relative thereto.

Electric machines can be operated as motors or generators.

One important aspect in the design of electric machines is the thermal behavior thereof. It is particularly important that the maximum temperature in the most sensitive parts of the machine is not exceeded. Otherwise, it would be possible, for example, that short circuits occur and permanently damage the machine. In this case, overheating may cause a breakdown of the insulation of the stator winding and/or a demagnetization of permanent magnets in the case of permanent-magnet excited machines.

The thermal limits ultimately define the output of the machine.

It is known that the operation of the machine as a motor is at high torque associated with a significant heat development in the stator winding and in the stator core as a result of losses.

The dissipation of heat losses in electric machines is realized with a combination of heat conduction within solid and laminated components and convection on surfaces that are in contact with air or cooling liquids or other gases. Heat losses generated in the stator winding are radially and circumferentially dissipated from the coil sides into the stator core along the slot liner and furthermore outward into the stator housing. A large part of the overall machine losses is dissipated along this path.

Efficient cooling of the stator winding and the stator core therefore is of the utmost importance in the design of electric machines. Efficient cooling not only can prevent overheating of the machine or of machine components at peak load, but also improve the efficiency of the machine under normal conditions.

It is the objective of the present invention to develop an electric machine that has sound thermal properties and can be manufactured with little effort.

This objective is presently attained with the object of Claim 1.

Advantageous embodiments and enhancements are disclosed in the dependent claims.

In one embodiment, an electric machine features a stator and rotor that is movably supported relative thereto. The stator comprises a plurality of slots for accommodating a stator winding. A conductor section of the stator winding is respectively placed into each slot. On one side of the stator, the conductor sections are electrically short-circuited with one another in a short-circuit means. The short-circuit means comprises a cooling device.

The conductor sections may be connected, for example, to a power supply unit on the far side of the stator referred to the short-circuit means. This makes it possible, for example, to individually feed a phase current to each conductor section as described in greater detail below.

The short-circuit means, as well as the conductor sections in the slots of the stator, can be manufactured with little effort and installed in the stator. This also applies to the cooling device comprised by the short-circuit means.

The heat losses of the stator winding are dissipated exactly at the location, at which they are generated. This results in particularly advantageous thermal properties of the machine. The conductor sections and the short-circuit means naturally have a sound electrical conductivity, i.e. a low resistance. Most materials of this type also provide very good thermal conductivity. This means that the heat losses generated in the entire winding and, in particular, the heat losses present in the conductor sections are also very well transferred into the short-circuit means and dissipated at this location by the cooling device.

Consequently, alternative cooling systems such as, for example, cooling ribs and air being blown over said cooling ribs, for example, by means of a fan can be eliminated. In addition, no cooling channels are required within the stator housing.

In fact, direct cooling of the conductor sections of the stator winding is presently realized by cooling the short-circuit means.

The short-circuit means may be realized, for example, in the form of a short-circuit ring. Such a short-circuit ring can be manufactured in a particularly simple fashion. The design and the function of such a short-circuit ring are known in principle from a different application, namely in the form of a short-circuit armature, i.e. a rotor in asynchronous machines. In contrast to the proposed principle, however, short-circuit rings are provided on both sides of the conductor sections in a short-circuit armature.

In one embodiment, the short-circuit ring is realized in a hollow fashion, which means that it has, for example, a rectangular cross section, within which a cooling channel is located. The cooling channel therefore is also designed annularly and integrated into the short-circuit ring.

An annular cooling channel may alternatively or additionally be arranged directly adjacent to the short-circuit ring in the axial and/or radial direction and connected thereto over the largest surface possible in order to ensure sound thermal conductivity from the short-circuit ring to the cooling channel.

In one embodiment, the short-circuit ring and the adjacently arranged cooling channel have the same inside and outside diameters.

The short-circuit ring and the cooling channel may be in direct contact with one another or connected to one another by means of a thermally conductive medium such as, for example, an adhesive layer.

Instead of the essentially rectangular cross section of the annular cooling channel, it would also be possible to consider other cross-sectional shapes such as, for example, an L-shaped, U-shaped or elliptical cross section.

The U-shaped cooling channel is in one embodiment arranged in such a way that the opening of the U is axially oriented toward the machine.

For example, a liquid or gaseous cooling medium that brings about the cooling effect may flow through the cooling channel.

The cooling device features at least one cooling medium supply line and one cooling medium discharge line for connecting the cooling device, for example, to a heat exchanger that can absorb heat from the cooling medium. Other known cooling devices such as, for example, evaporators may also be used instead of a heat exchanger.

Single-circuit or multiple-circuit cooling systems may be utilized in this case.

In one embodiment, the conductor sections are respectively realized straight. This results in a particularly cost-efficient manufacture of the stator slots and the winding.

The conductor sections themselves may, for example, have a rectangular, round or oval cross section.

The conductor sections may comprise aluminum rods, copper rods or bronze rods.

The proposed principle makes it possible to directly dissipate ohmic losses generated in the region around the cooling device of the short-circuit means.

Heat present or generated in the conductor sections or directly adjacent to the conductor sections of the stator winding or in the power supply units connected to the conductor sections is effectively transferred to the short-circuit means by the conductor sections and then transported away by the cooling device. The thermal conductivity of copper or aluminum is 5× to 8× higher than that of iron. Consequently, the winding itself is better suited for the heat transfer than the stator core.

All in all, the proposed principle results in a superior cooling effect, for example, in comparison with the arrangement of cooling channels in the iron of the stator core. The thermal resistance for the heat transfer to the short-circuit means via the conductor sections is very low and therefore allows very efficient cooling of the stator winding.

The present cooling also functions well with respect to the losses in the stator iron. This is the result of a low thermal resistance between the region around the stator core and the conductor sections of the stator winding. In the proposed winding, no slot liner is required between individual conductor sections and stator teeth or the yoke, respectively. This results in a low overall thermal resistance for the heat transfer from the stator core to the cooling device of the short-circuit means.

The L-shaped cross section of the cooling channel of the cooling device leads to an enlarged convection surface such that the cooling effect is additionally improved.

Other details of the proposed principle are elucidated below with reference to several exemplary embodiments that are illustrated in the figures.

In the figures, identical or identically acting components are identified by the same reference symbols.

In these figures:

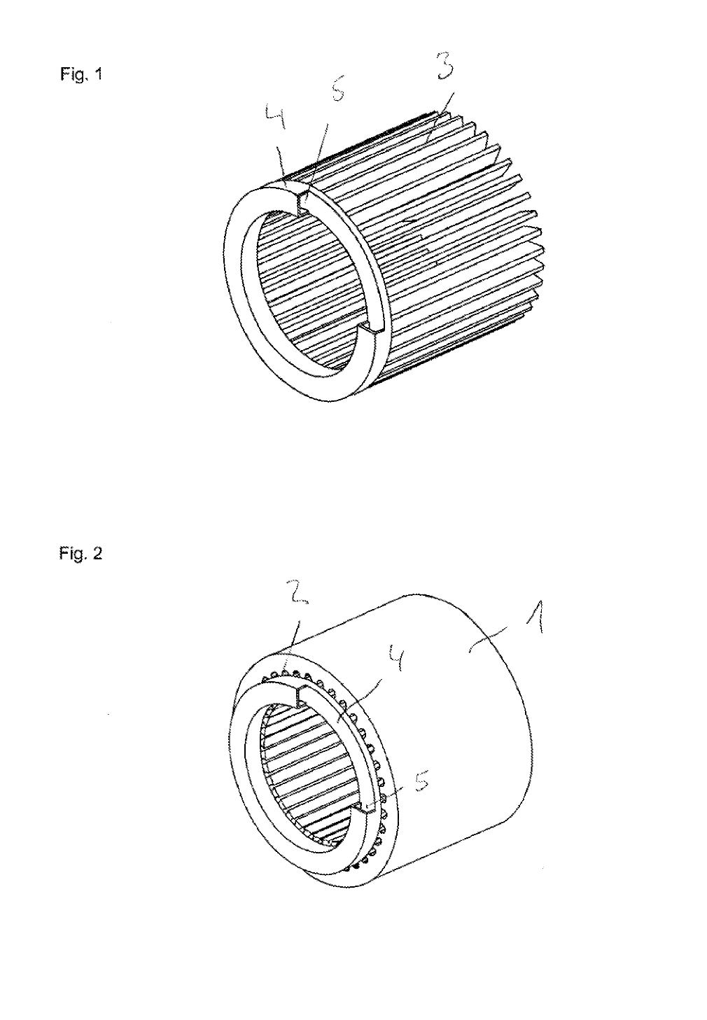

FIG. 1 shows a first exemplary embodiment of a winding system for a stator according to the proposed principle,

FIG. 2 shows the stator of the exemplary embodiment according to FIG. 1,

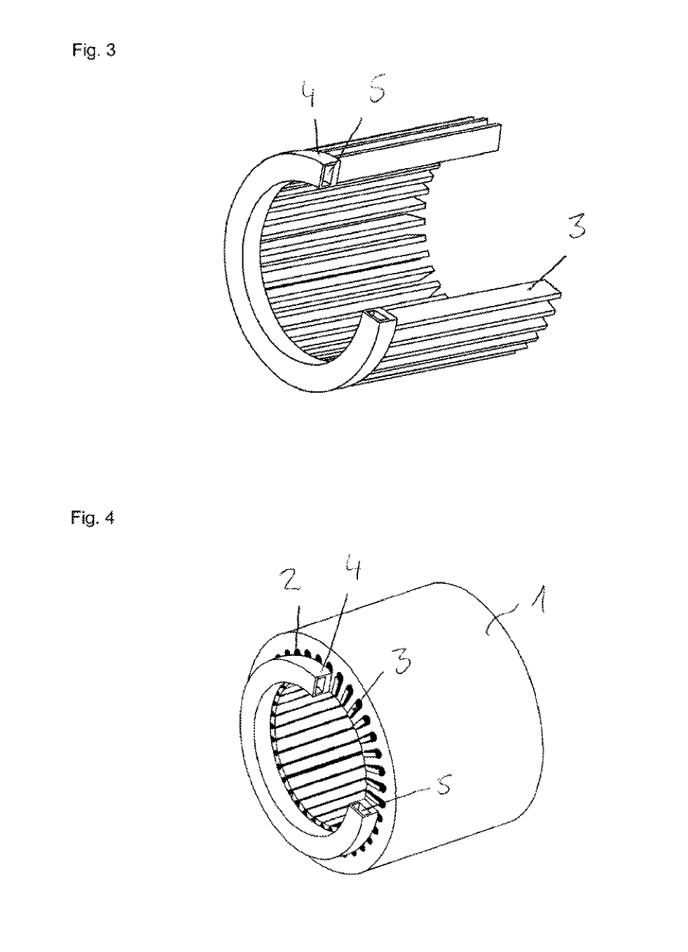

FIG. 3 shows a second exemplary embodiment of a winding system for a stator according to the proposed principle,

FIG. 4 shows the stator of the exemplary embodiment according to FIG. 3,

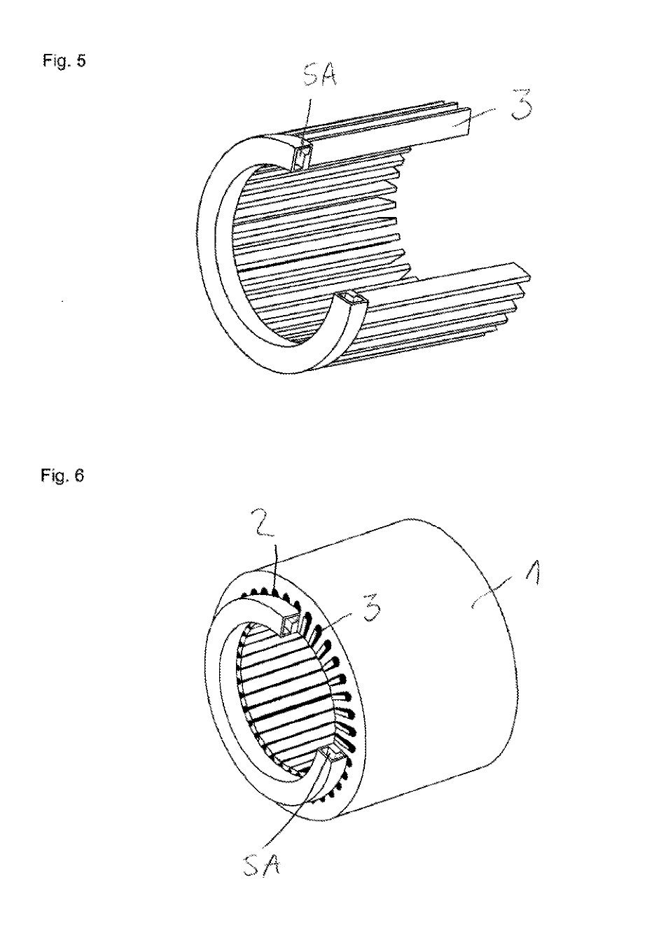

FIG. 5 shows a third exemplary embodiment of a winding system for a stator according to the proposed principle,

FIG. 6 shows the stator of the exemplary embodiment according to FIG. 5,

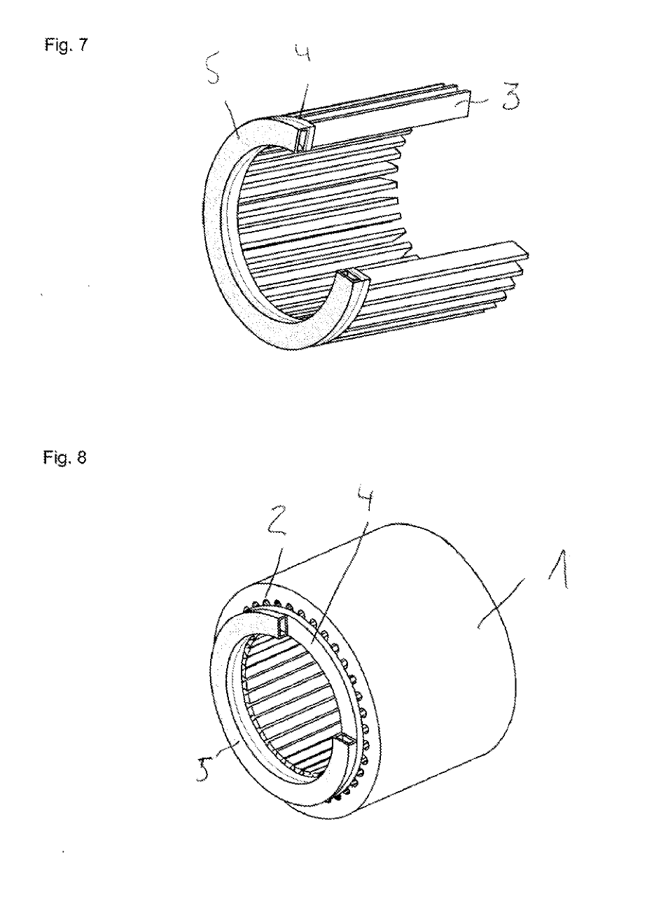

FIG. 7 shows a fourth exemplary embodiment of a winding system for a stator according to the proposed principle,

FIG. 8 shows the exemplary winding system according to FIG. 7 inserted into the slots of the corresponding stator,

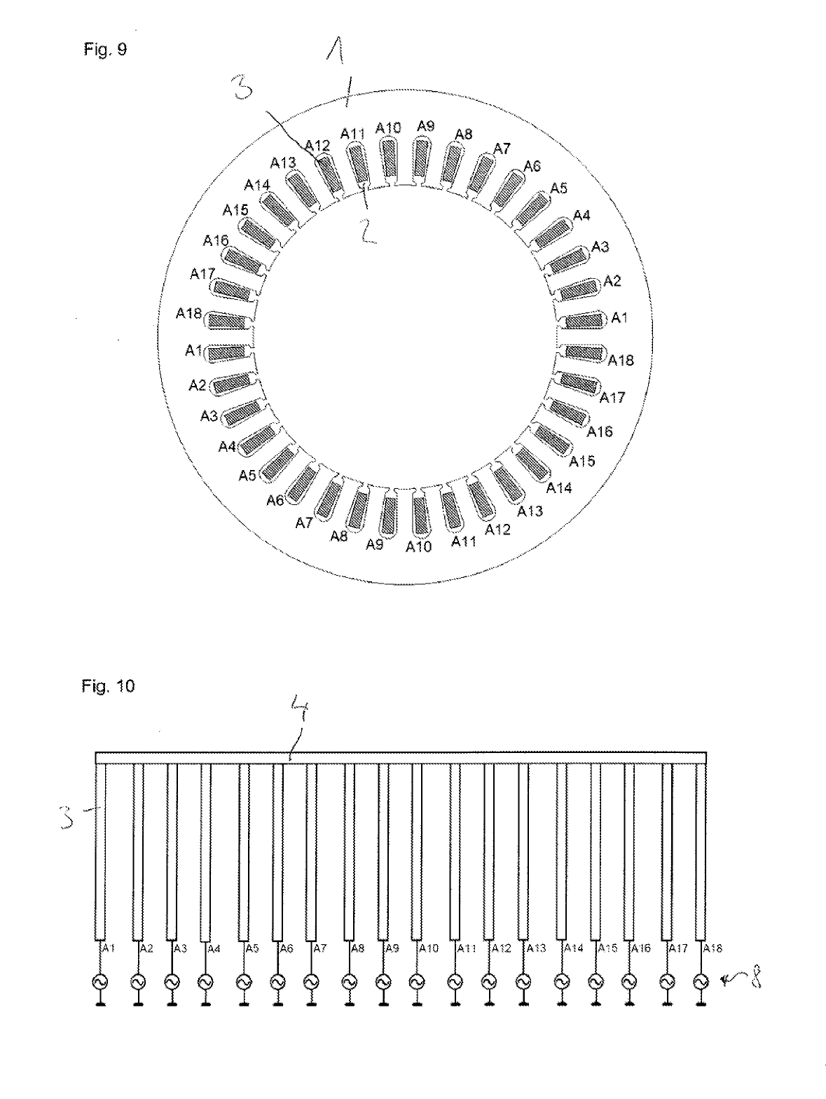

FIG. 9 shows a cross section through an exemplary embodiment of a stator according to the proposed principle,

FIG. 10 shows an exemplary power supply unit for the winding system of the stator,

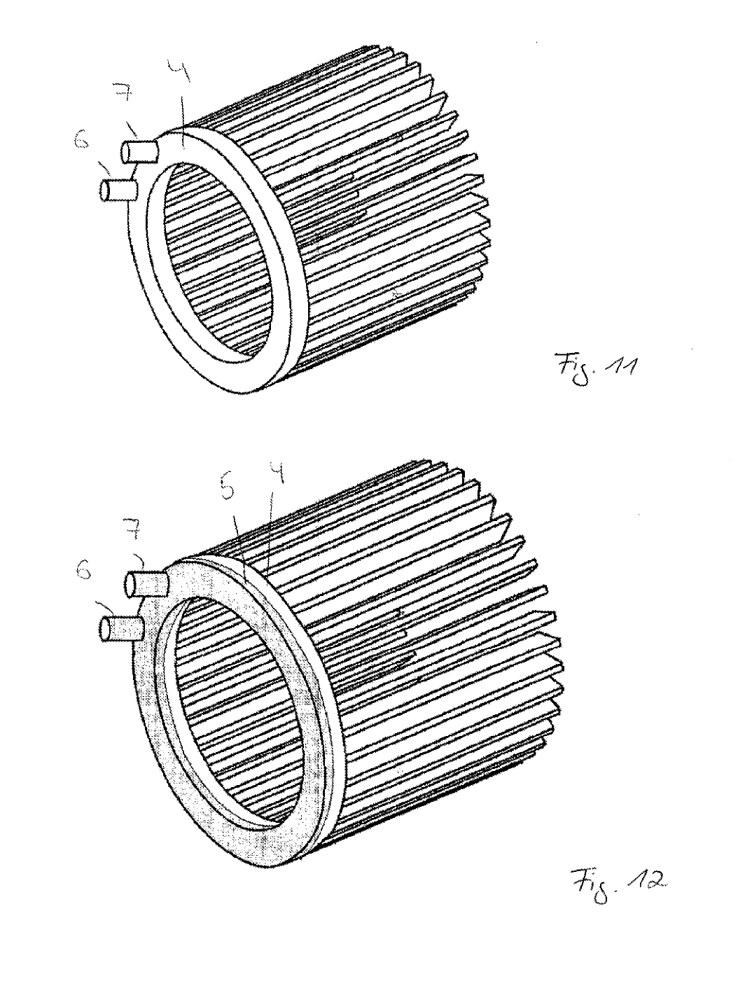

FIG. 11 shows an exemplary enhancement of the embodiment according to FIG. 1,

FIG. 12 shows an exemplary enhancement of the embodiment according to FIG. 7,

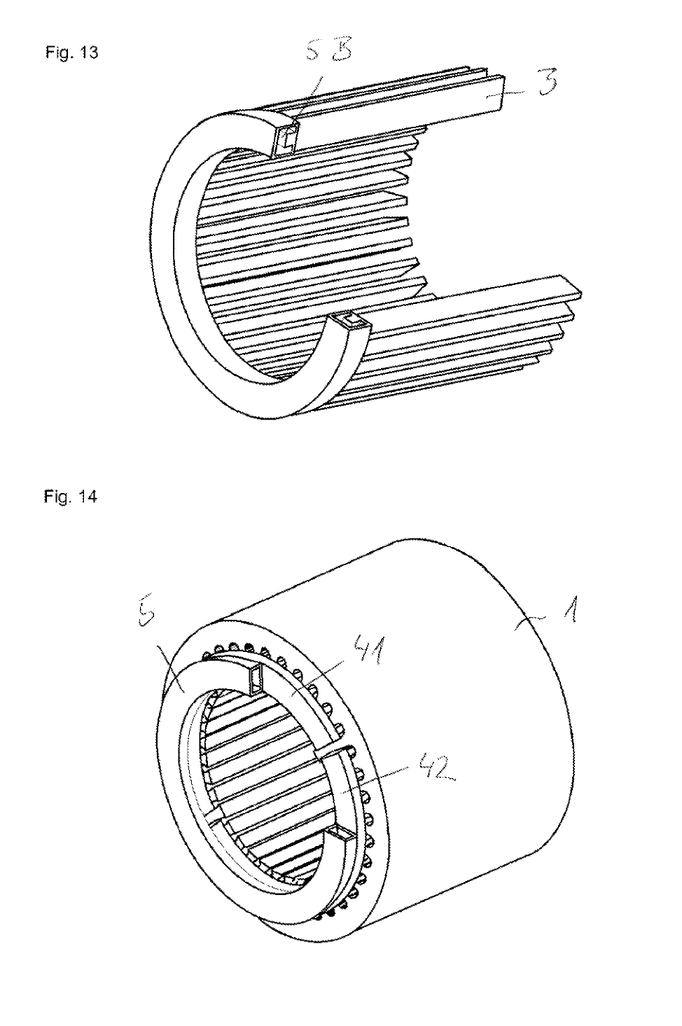

FIG. 13 shows an exemplary embodiment with a U-shaped cooling channel,

FIG. 14 shows an exemplary embodiment with several pairs of poles and several partial short-circuit rings,

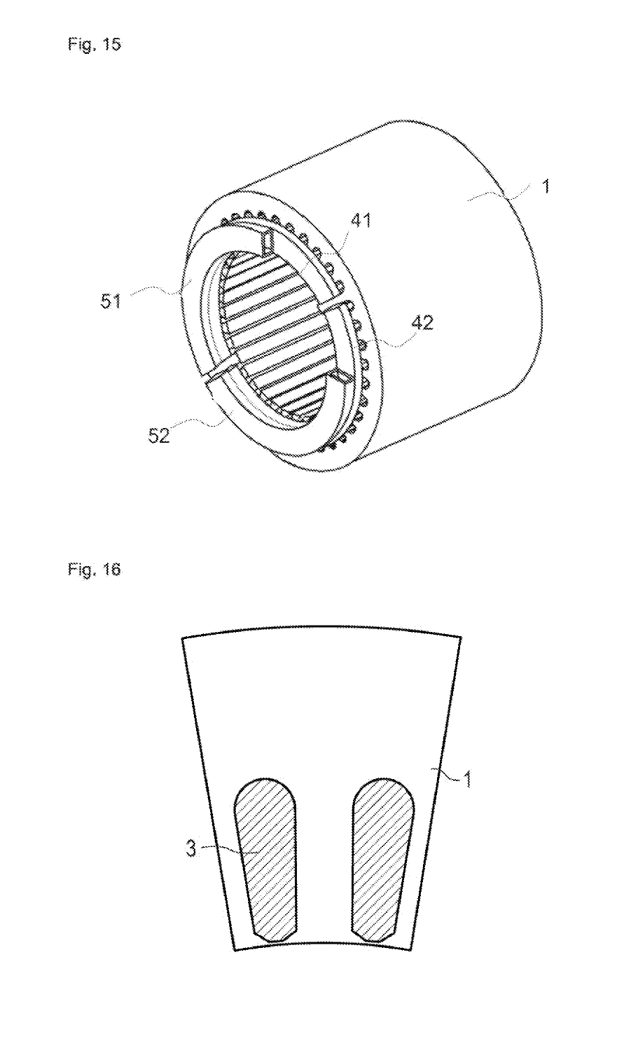

FIG. 15 shows another exemplary embodiment with several pairs of poles and several partial short-circuit rings,

FIG. 16 shows a detail of an example of the stator with conductor sections,

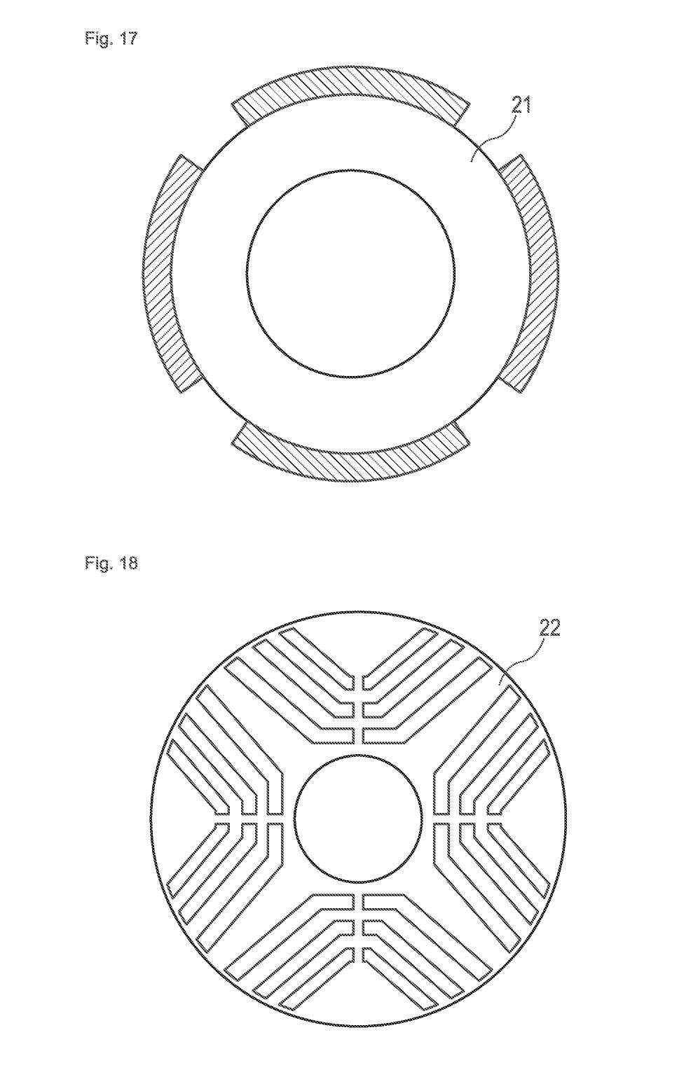

FIG. 17 shows an exemplary embodiment of the rotor in the form of a permanent-magnet rotor,

FIG. 18 shows an exemplary embodiment of the rotor in the form of a reluctance rotor,

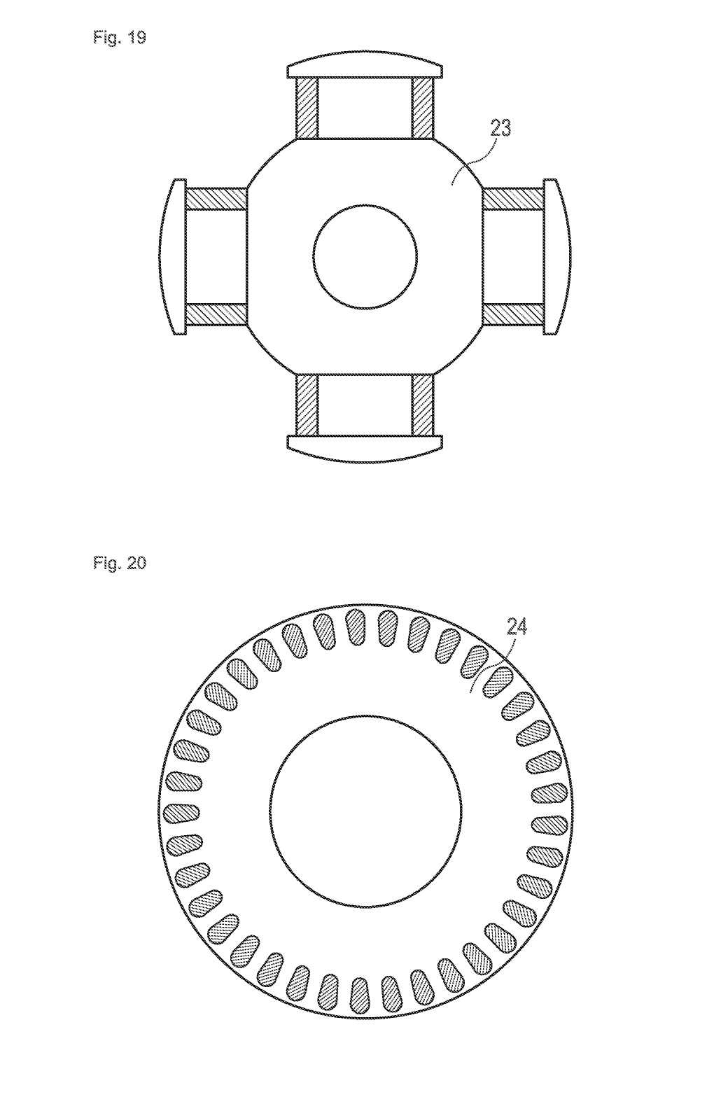

FIG. 19 shows an exemplary embodiment of the rotor in the form of a current-excited rotor, and

FIG. 20 shows an exemplary embodiment of the rotor in the form of an asynchronous rotor.

FIG. 1 shows a first exemplary embodiment of a winding system for a stator of an electric machine in the form of a perspective representation. The winding system comprises a plurality of straight conductor sections 3 that extend in the axial direction and are uniformly distributed along the circumference of the rotor. One end of each conductor section 3 is connected to a short-circuit means realized in the form of a short-circuit ring 4. The short-circuit ring 4 features a cooling device 5 that is realized in the form of an annular cooling channel with rectangular cross section in this case. The straight conductor sections 3 are realized solid and have an essentially cuboid shape. The conductor sections are in this case oriented parallel to the axis of the machine.

On their end face, the conductor sections 3 are connected to the short-circuit ring 4 in such a way that a large-surface electrically and thermally conductive connection is produced. The electrical connection serves for short-circuiting the ends of the conductor sections with one another whereas the thermal connection serves for realizing a sound heat transfer from the conductor sections 3 to the cooled short-circuit ring 4. The cooling channel of the cooling device 5 is designed in such a way that a fluid such as a cooling fluid or a gas can flow through said cooling channel during the operation of the machine. The cooling medium serves for dissipating heat losses generated during the operation of the electric machine.

The manufacturing effort for the winding shown is very low. The basic design corresponds to a short-circuit armature of an asynchronous machine, wherein the proposed stator winding is in contrast to a short-circuit armature only short-circuited on one side. The free ends of the conductor sections are connected to a power supply unit that respectively makes available individual phase currents as described in greater detail below.

FIG. 2 shows the winding according to FIG. 1 with the conductor sections 3, the short-circuit ring 4 and the integrated cooling device 5 installed into a stator 1. In this case, the number of slots 2 in the stator 1 exactly corresponds to the number of conductor sections 3 provided. The slots 2 are distributed along the circumference of the stator 1 and extend in the axial direction analogous to the conductor sections 3.

In the present example, the stator 1 features a total of 36 slots 2 that can accommodate the 36 conductor sections 3 of the stator winding. It can be immediately gathered that the stator winding with the short-circuit ring and the cooling device not only can be easily manufactured, but that the installation thereof into the stator slots can also be carried out in a very simple fashion.

The supply and the discharge of cooling medium to/from the cooling channel integrated into the short-circuit ring are not illustrated in FIGS. 1 and 2 in order to provide a better overview. The ohmic losses in the region of the short-circuit ring can be cooled directly. Ohmic losses in the region of the conductor sections can be very efficiently dissipated because the heat caused thereby is axially conducted to the short-circuit ring and from there to the cooling medium in the cooling channel. Since the thermal conductivity of the conductor sections, which comprise a material such as copper or aluminum, is very high in comparison with iron, for example 5-times to 8-times as high, the thermal resistance for the heat transfer through the conductor sections is very low. This not only results in simple cooling of the stator winding, but also in highly effective cooling thereof.

According to FIG. 2 and also FIG. 16, a low thermal resistance exists between the stator core and the conductor sections 3. In this exemplary embodiment, no slot liner is required between the conductor sections 3 and the stator slots 2 or the stator yoke, respectively. The overall thermal resistance for the heat transfer from the stator core to the cooling channel of the short-circuit ring 4 is therefore low, wherein this in turn also leads to efficient cooling of the heat generated by stator core losses.

FIGS. 3 and 4 are based on the exemplary embodiment according to FIGS. 1 and 2, but show an alternative cross section in order to better elucidate the design and the function according to the proposed principle. In this respect, a repeated description of the design and the advantageous function is not provided at this point.

FIGS. 5 and 6 show a different design of the cooling channel in the cooling device 5 which is based on FIGS. 3 and 4.

In the exemplary embodiment according to FIGS. 5 and 6, the cooling channel 5a is not realized with a rectangular cross section, but rather with an L-shaped cross section. In this case, the longer limb of the L-shape is oriented in the radial direction and the shorter limb is oriented in the axial direction. This results in an improved cooling effect as described in greater detail below. A temperature exchange caused by convection takes place within the cooling channel 5a. The heat transfer rate is in this case dependent on the total temperature difference between the walls of the cooling channel and the fluid, as well as on the convection surface A_{c}. The convection resistance Rconv between the inner surface of the cooling channel 5a and the fluid is calculated in accordance with

$${R}_{conv} = \frac{1}{{h}_{c} \cdot {A}_{c}}$$

wherein the quantity h_{c} is referred to as the convection heat transfer coefficient.

According to the formula, the convection resistance can be reduced by increasing the convection surface of the cooling channel. The embodiment according to FIGS. 5 and 6 shows exactly this enlarged surface of the cooling channel, which is achieved with the L-shape.

FIGS. 7 and 8 show an alternative embodiment that is based on FIGS. 1 and 2. In this case, FIG. 7 once again shows a detail of the winding system with the cooling device whereas FIG. 8 shows the stator with the winding system according to FIG. 7.

In contrast to the exemplary embodiment according to FIGS. 1 and 2, the cooling channel is not integrated into the short-circuit ring 4 in the example according to FIGS. 7 and 8. In fact, a separate cooling device is provided in the embodiment according to FIGS. 7 and 8 and flanged to the short-circuit ring 4 in the axial direction. In this case, the short-circuit ring 4, as well as the cooling channel of the cooling device 5, has a rectangular cross section, wherein the short-circuit ring is realized solid whereas the cooling device 5 forms a hollow space with rectangular cross section. The cooling device and the short-circuit ring naturally are connected to one another over a large surface in the axial direction, wherein this connection must have sound thermal conductivity, but not necessarily sound electrical conductivity. Several assembly techniques such as, for example, an adhesive with corresponding properties can be used for producing such a connection between the cooling device and the short-circuit ring. In this example, the short-circuit ring 4 and the cooling channel of the cooling device 5 have the same inside diameter and the same outside diameter.

FIG. 9 shows a cross section through the stator 1 according to the proposed principle. This figure particularly shows the total of 36 slots 2 that are arranged along the circumference and accommodate the conductor sections 3. The slots 2 extend in the axial direction and are illustrated in the form of a cross section. One conductor section 3 is respectively arranged in each slot.

The winding has 18 phases that are identified by A1, A2, . . . , A18. The machine is designed as a four-pole machine and its number of pairs of poles therefore is 2. Each phase A1 to A18 therefore occurs twice, wherein the corresponding conductor sections supplied with the same electric phase are offset relative to one another by 180°.

A rotor is provided within the stator, wherein said rotor is rotatably supported and identified by the reference symbol 21.

FIG. 10 shows the stator windings in the form of a simplified developed view. It can be gathered that the short-circuit ring 4 is connected to 18 conductor sections 3 that are assigned to electric phases identified by the reference symbols A1 to A18. A power supply unit 8 features a total of 18 terminals, by means of which corresponding phase currents can be individually generated and fed into the conductor sections 3.

With respect to the design of the power supply unit, the structure of the winding of the stator, as well as potential modifications and advantageous embodiments, we refer to prior patent application DE 102014105642.6 of the applicant in its entirety.

FIG. 11 shows an exemplary enhancement of the embodiment according to FIG. 1. In this case, a supply line 6 and a discharge line 7 for supplying and discharging a cooling medium in the form of a fluid are respectively provided on the end face of the short-circuit ring 4 with integrated cooling channel. For example, the supply and discharge lines 6, 7 respectively have a round cross section. Other shapes naturally may also be considered.

FIG. 12 shows an exemplary enhancement of the embodiment according to FIG. 7. In this case, a supply line 6 and a discharge line 7 for supplying and discharging a cooling medium in the form of a fluid are respectively provided on the end face of the annularly designed cooling device 5. For example, the supply and discharge lines 6, 7 respectively have a round cross section. Other shapes naturally may also be considered.

FIG. 13 shows an exemplary embodiment with a U-shaped cooling channel 5B. The opening of the U is axially oriented toward the machine. This embodiment is based on the embodiment according to FIG. 5, wherein the L-shape of the cooling channel cross section is replaced with a U-shape in this case. In this way, the effective surface available for the transfer of heat losses from the short-circuit ring into the cooling medium is additionally increased.

FIG. 14 shows an exemplary embodiment of the stator winding with several pairs of poles. In this example, the short-circuit means comprises two electrically separated partial short-circuit rings 41, 42 that respectively short-circuit half of the conductor sections 3 with one another in this case. Each of the two partial short-circuit rings 41, 42 connects the conductor sections 3 of one pair of poles to one another. A single annular cooling channel is furthermore provided.

FIG. 15 shows another exemplary embodiment with several pairs of poles. This embodiment corresponds to FIG. 14 with respect to the division of the short-circuit ring into two parts 41, 42. In contrast to FIG. 14, however, the cooling channel in FIG. 15 is not realized in the form of a single annular cooling channel, but rather also consists of two parts 51, 52 that respectively have a semicircular shape analogous to the short-circuit ring. On their respective end faces, the two partial cooling channels 51, 52 are connected to the respective partial short-circuit rings 41, 42 on the machine.

Based on a detail of an embodiment of the stator, FIG. 16 shows that the conductor section 3 respectively can completely fill out the slot. In this way, the slot space factor can be increased to 100%. This winding can be manufactured together with the one-sided short-circuit ring 4, for example, by means of a diecasting process such that the manufacturing costs of the machine are additionally reduced.

FIGS. 17-20 show exemplary rotors suitable for use in accordance with the proposed principle. FIG. 17 shows a permanent-magnet rotor 21, FIG. 18 shows a reluctance rotor 22, FIG. 19 shows a current-excited rotor 23 and FIG. 20 shows an asynchronous rotor 24.

Since these rotors consist of generally known rotors of electric machines, they are not elucidated in greater detail at this point.

What is claimed is:

1. An electric machine with a stator and a rotor that is movably supported relative thereto, wherein:
the stator comprises a plurality of slots for accommodating a stator winding,
one conductor section of the stator winding is respectively placed into each slot,
the conductor sections of at least one pair of poles are short-circuited with one another on a first side of the stator in a short-circuit means, and
the short-circuit means comprises a cooling device.

2. The electric machine according to claim 1,
wherein a short-circuit ring is provided for short-circuiting the conductor sections and the short-circuit ring comprises an annular cooling channel for conveying a fluid.

3. The electric machine according to claim 2,
wherein the annular cooling channel is integrated into the short-circuit ring.

4. The electric machine according to claim 3,
wherein the annular cooling channel has a rectangular cross section.

5. The electric machine according to claim 3,
wherein the annular cooling channel has an essentially L-shaped or U-shaped or elliptical cross section.

6. The electric machine according to claim 2,
wherein the annular cooling channel is arranged adjacent to the short-circuit ring in the axial and/or radial direction and thermally coupled thereto.

7. The electric machine according to one of claims 1 to 6,
wherein the conductor sections are respectively connected to a terminal of a power supply unit on a second side of the stator that lies opposite of the first side.

8. The electric machine according to one of claims 1 to 6,
wherein the conductor sections are respectively supplied with a separate electric phase by the power supply unit.

9. The electric machine according to claim 8,
wherein the number of phases amounts to at least 3.

10. The electric machine according to claim 8,
wherein the number of phases amounts to at least 4.

11. The electric machine according to claim 8,
wherein the number of phases amounts to at least 5.

12. The electric machine according to claim 8,
wherein the number of phases amounts to at least 10.

13. The electric machine according to one of claims 1 to 6,
wherein the respective conductor sections placed into the slots are straight.

14. The electric machine according to one of claims 1 to 6,
wherein the respective conductor sections placed into the slots comprise aluminum rods, copper rods or bronze rods.
